(19) United States
(12) Patent Application Publication
(10) Pub. No.: US 2026/0259536 A1
(43) Pub. Date: Sep. 3, 2026

(54) DEVICE CONTROL SYSTEM, DEVICE CONTROL APPARATUS, DEVICE CONTROL METHOD, AND DEVICE CONTROL PROGRAM

(71) Applicant: Mitsubishi Electric Corporation, Tokyo (JP)

(72) Inventors: Aki KIMURA, Tokyo (JP); Hiroaki TAKAHASHI, Tokyo (JP); Wataru SASAKI, Tokyo (JP)

(73) Assignee: Mitsubishi Electric Corporation, Tokyo (JP)

(21) Appl. No.: 18/878,856

(22) PCT Filed: Jun. 29, 2022
(86) PCT No.: PCT/JP2022/026021

§ 371 Date: Dec. 24, 2024

(51) Int. Cl. G05B 15/02; G06F 3/01

(52) U.S. Cl. CPC G05B 15/02; G06F 3/011

(57) ABSTRACT

A device control system includes: a device that changes an environment of a target area; an environment detector; a physical state detector; and a device control apparatus. The device control apparatus includes: a target acquiring unit that acquires target information indicating a target state of action of multiple people in the target area; an environment information acquiring unit that acquires environment information indicating a state of the environment of the target area including the multiple people, from the environment detector; a physical state information acquiring unit that acquires physical state information indicating physical states of the multiple people, from the physical state detector; and a controlling unit that controls the device such that states of action of the multiple people approach the target state, based on the target information, the environment information, and the physical state information.

### TECHNICAL FIELD

The present disclosure relates to a device control system, a device control method, a device control apparatus, and a device control program.

### BACKGROUND ART

For example, Patent Reference 1 proposes a device that improves the sense of emotional unity among multiple people in the same vehicle by detecting biological information and controlling an emotion enhancement means to bring emotions of the multiple people closer together when the emotions of the multiple people are distant from each other.

### PRIOR ART REFERENCE

### Patent Reference

Patent Reference 1 Japanese Patent Application Publication No. 2016-137871

### SUMMARY OF THE INVENTION

### Problem to be Solved by the Invention

In general, in gathering of multiple people (e.g.) meetings), it is desirable to reach beneficial conclusions through active discussions, and also to avoid situations where discussions do not progress and beneficial conclusions cannot be obtained because Of an excessively active person (e.g., excessively excited person) The device proposed by Patent Reference 1, however, is intended to bring emotions of multiple people closer together, and the device does not have the function for activating or calming the states of the multiple people.

It is therefore an object of the present disclosure to bring the states of multiple people in a target area closer to a target state,

### Means of Solving the Problem

A device control system according to the present disclosure includes: a device that changes an environment of a target area; an environment detector that detects a state of the environment; a physical state detector that detects a physical state of a person; and a device control apparatus, wherein the device control apparatus includes a target acquiring unit that acquires target information indicating a target state of action of multiple people in the target area, an environment information acquiring unit that acquires environment information indicating a state of the environment of the target area including the multiple people, from the environment detector, a physical state information acquiring unit that acquires physical state information indicating physical states of the multiple people, from the physical state detector, and a controlling unit that controls the device such that states of action of the multiple people approach the target state, based on the target information, the environment information, and the physical state information.

A device control method according to the present disclosure is a method to be performed by a device control apparatus that controls a device for changing an environment of a target area, and includes: acquiring target information indicating a target state of action of multiple people in the target area; acquiring environment information indicating a state of the environment of the target area including the multiple people, from an environment detector that detects the state of the environment; acquiring physical state information indicating physical states the multiple people from a physical state detector that detects a physical state of a person; and controlling the device such that states of action of the multiple people approach the target state, based on the target information, the environment information, and the physical state information.

### Effects of the Invention

According to the present disclosure, states of multiple people in a target area can approach a target state.

### BRIEF DESCRIPTION OF THE DRAWINGS

FIG. 1 is a block diagram schematically illustrating configuration of a device control system according to a first embodiment.

FIG. 2 is a block diagram schematically illustrating a configuration of a device control apparatus according to the first embodiment.

FIG. 3 is a diagram illustrating an example of a hardware configuration of the device control apparatus according to the first embodiment.

FIG. 4 is a diagram illustrating an example of a device of the device control system according to the first embodiment.

FIG. 5 is a diagram illustrating an example of an environment detector of the device control system according to the first embodiment.

FIG. 6 is a diagram illustrating an example of a physical state detector of the device control system according to the first embodiment.

FIG. 7 is a diagram showing an example of activeness distribution.

FIG. 8 is a flowchart showing a process of the device control apparatus according to the first embodiment.

FIG. 9 is a flowchart showing a calculation process of a current value of activeness in FIG. 8.

FIG. 10 is a flowchart showing control of the device of the device control apparatus according to the first embodiment.

FIG. 11 is a block diagram schematically illustrating a configuration of a device control system according to a second embodiment.

FIG. 12 is a block diagram schematically illustrating a configuration of a device control apparatus according to the second embodiment.

FIG. 13 is a table showing an example of a correlation between Big Five personality traits and operation of a household electrical appliance.

FIG. 14 is a flowchart showing calculation of personal characteristics by the device control apparatus according to the second embodiment.

FIG. 15 is a flowchart showing a process of the device control apparatus according to the second embodiment.

### MODE FOR CARRYING OUT THE INVENTION

Device control systems, device control apparatuses, device control methods, and device control programs according to embodiments will be described with reference to the drawings. The following embodiments are merely examples, and the embodiments may be combined as appropriate and each embodiment may be changed appropriate,

### <1> First Embodiment

### <1-1> Configuration

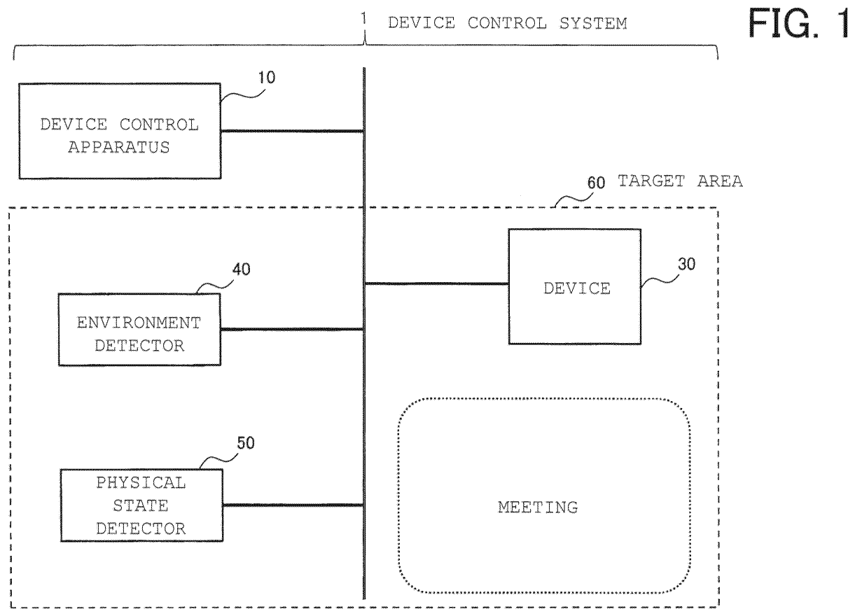

FIG. 1 is a block diagram schematically illustrating configuration of a device control system 1 according to a first embodiment. The device control system 1 is a system for bringing states of multiple people (e.g., participants of a meeting) in target area 60 closer to a target state. The multiple people in the target area 60 may be unrelated to each other (i.e., strangers). The multiple people in the target area 60 may be people gathered in a public space (e.g., inside a train, a shopping mall, a school, a hospital, etc.). FIG. 1 shows the target area 60 as a single area, but the target area 60 may be constituted by a plurality of areas in which meeting systems (e.g., teleconference systems or Web conference systems, etc.) are installed, each of which is a communication system that enables people in remote locations to participate in the meeting.

The target state of the multiple people in the target area 60 is, for example, a goal of a meeting set by, for example, a participant of the meeting or a manager of the meeting. For example, in a case where the goal of the meeting is to obtain beneficial conclusions through active discussions, high activeness (e.g., high value corresponding to high activeness) indicating that activeness of actions (e.g., activeness of discussions) of multiple people participating in the meeting is increased is set as a target state. In the case of avoiding occurrence of an excessively active person (e.g., excessively excited person), low activeness (e.g., low value corresponding to low activeness) indicating that activeness of action of multiple people participating in the meeting is reduced is set as a target state. The target state of multiple people in the target area 60 may be determined based on a state of a specific person (e.g., specific one or more people previously determined) among the multiple people in the target area 60. That is, as the target state of the multiple people in the target area 60, the states of all the multiple people are not necessarily used but it is sufficient use the state of at least one representative (e.g., person in charge of the meeting) among the multiple people. In a case where the target area 60 is in a house, the state of someone in the family may be used as the target state of the multiple people in the target area 60.

A positive correlation is supposed to be present between activeness of action of a person and excitement level of the person, and the excitement level of a person can be measured based on a physical state (e.g., biological information) of the person. For example, an increase in excitement level of a person can be measured based on a physical state such as an increase in body temperature, an increase in pulse rate, an increase in blood pressure, increase in speech sound, an increase in speech speed, and a gesture during speech. In this manner, the device control system 1 is a system that measures activeness of action of multiple people (generally referred to as an “atmosphere of the place” formed by gathering of multiple people) by detecting the physical states of the multiple people and controls a device (e.g., electric equipment) to adjust an environment of the target area 60 to a state in accordance with a predetermined target state.

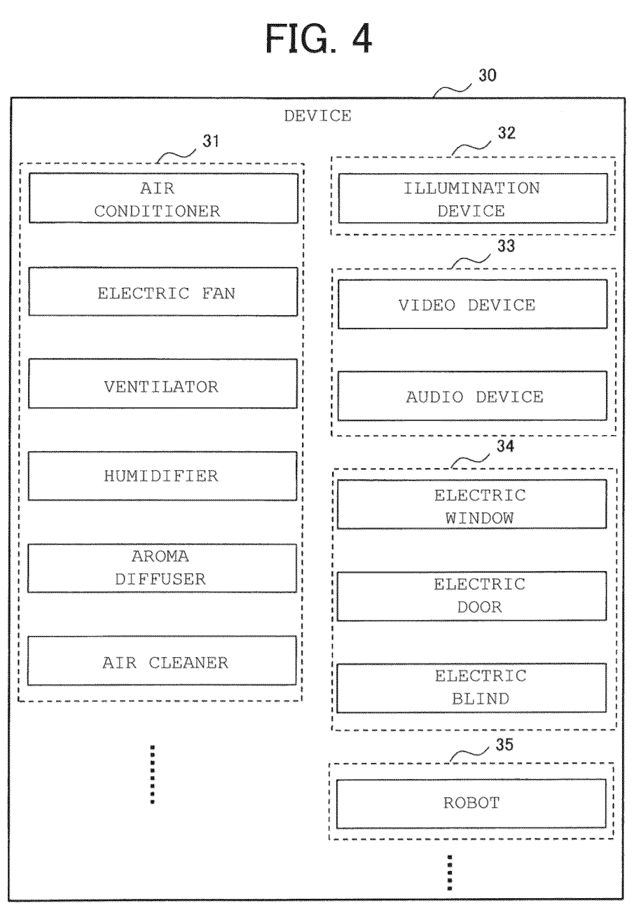

The device control system 1 includes a device 30 that changes an environment of the target area 60, an environment detector 40 that detects a state of the environment of the target area 60, a physical state detector 50 that detects a physical state of a person in the target area 60, and a device control apparatus 10 as an information processor for controlling the device 30. The device control system I may include a plurality of devices 30, a plurality of environment detectors 40, and a plurality of physical state detectors 50. The plurality of device control apparatuses 10 are apparatuses that can carry out a device control method according to the first embodiment. The device control apparatus 10 is, for example, a computer capable of executing a device control program according to the first embodiment. The device 30, the environment detector 40, and the physical state detector 50 are connected to the device control apparatus 10 through, for example, a wired or wireless network. Examples of the network include a local area network (LAN), a wide area network (WAN), and the Internet. The environment detector 40 may be part of the device 30. A specific example of the device 30 will be described later with reference to FIG. 4.

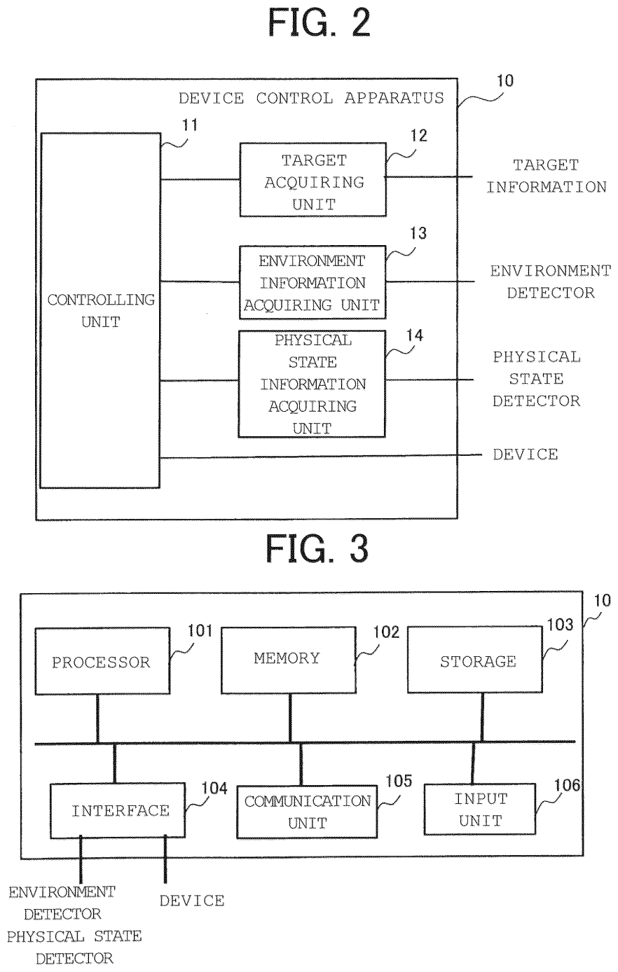

FIG. 2 is a block diagram schematically illustrating a configuration of the device control apparatus 10 according to the first embodiment. The device control apparatus 10 includes a target acquiring unit 12, an environment information acquiring unit 13, a physical state information acquiring unit 14, and a controlling unit 11.

The target acquiring unit 12 acquires target information A0 Indicating a target state of action of multiple people (e.g., participants of a meeting) in the target area 60 and provides the target information A0 to the controlling unit 11. The target information A0 is input from an input unit (shown in FIG. 3 described later) operated by a person to the target acquiring unit 12, for example. For example, the target acquiring unit 12 provides the target information A0 as target value A1 indicating the level of activeness of action of the multiple people in the target area 60, and provides the target value A1 to the controlling unit 11. The target acquiring unit 12 or the controlling unit 11 may dynamically change the target information A0. For example, in a case where the target information A0 is set at a target value, the target information A0 may be dynamically changed such that the target information A0 is set at a value for activating a discussion in a first half of a meeting and then set at a value for calming a discussion in a second half the meeting. The target information A0 may be automatically changed to a value for calming participants of the meeting if the participants are excessively excited.

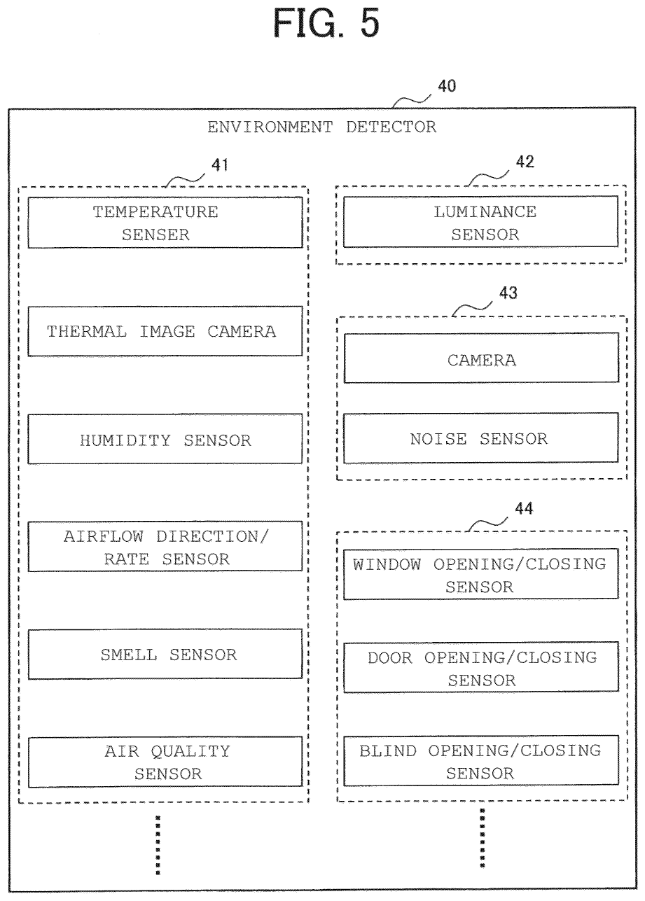

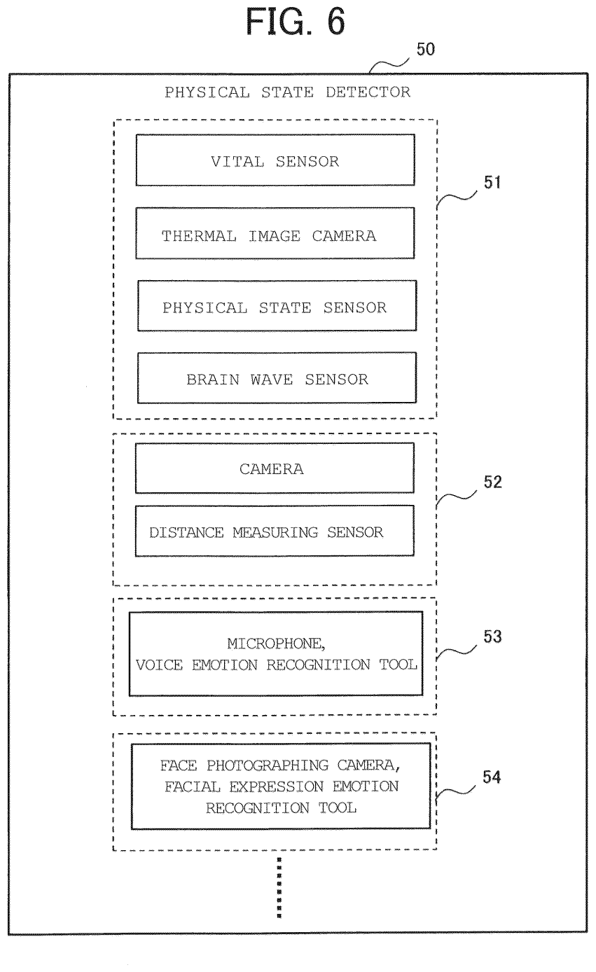

The environment information acquiring unit 13 acquires, from the environment detector 40, environment information B0 indicating a state of an environment of the target area 60 including multiple people, and provides the environment information B0 to the controlling unit 11. In a case where the environment detector 40 is part of the device 30, the environment information B0 can include device state information indicating a state of the device 30. For example, the environment information B0 may be an output signal of a temperature sensor installed as a different unit from an air conditioner as the device 30, or may be device state information (e.g., output signal of a temperature sensor in the air conditioner or a set temperature of the air conditioner, etc.). It should be noted that the device state information may be directly provided from the device 30 to the controlling unit 11 through a network. A specific example of the environment detector 40 will be described later with reference to FIG. 5.

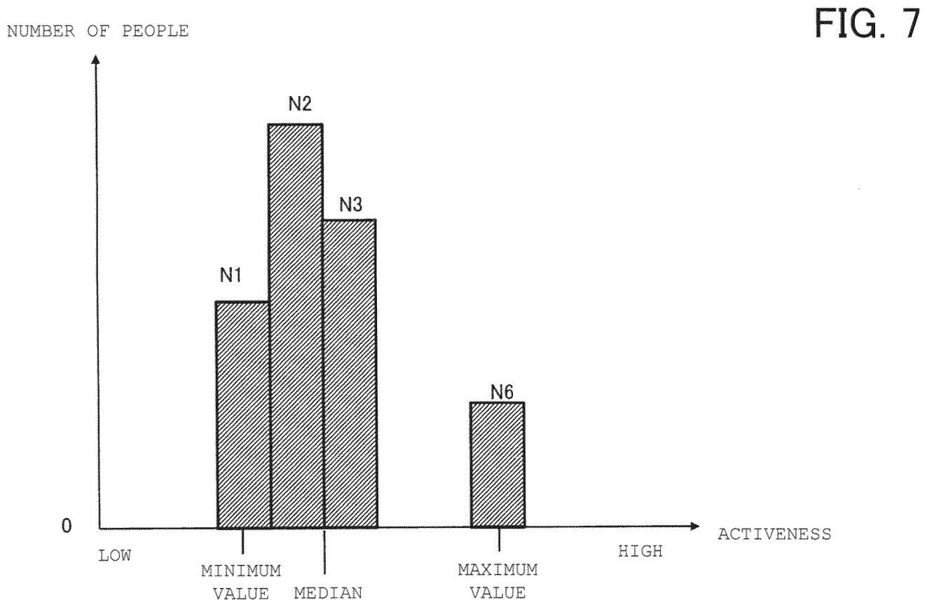

The physical state information acquiring unit 14 acquires, from the physical state detector 50, physical state information C0 indicating physical states of multiple people in the target area 60, and provides the physical state information C0 to the controlling unit 11. The physical state information C0 is information indicating an excitement level of a person and activeness of action of a person. A specific example of the physical state detector 50 will be described later with reference to FIG. 6.

Based on the target information A0, the environment information B0, and the physical state information C0, the controlling unit 11 controls the device 30 such that states of action of multiple people in the target area 60 approach a target state. The environment information B0 includes device state information. That is, the controlling unit 11 may not detect brightness of the target area 60 with a luminance sensor but may estimate the brightness from a state of an illumination device. In this case, the controlling unit 11 controls the device 30 such that states of action of multiple people in the target area 60 approach a target state based on the target information A0, device state information as the environment information B0, and the physical state information C0. The controlling unit 11 may not detect a temperature of the target area 60 with a temperature sensor and may estimate the temperature from a set temperature or an operating state of an air conditioner, In a case where the target acquiring unit 12 acquires the target information A0 as a target value (i.e., activeness target value) A1 indicating a level of activeness action of multiple people, the controlling unit 11 calculates a current value (i.e., activeness current value) A2 indicating a level of activeness of action of multiple people based on the physical state information C0 and controls the device 30 to obtain an environment where the current value A2 approaches the target value A1.

Activeness of action of multiple people is a value calculated from activeness of action of each of the multiple people. A current value of activeness of action of multiple people is, for example, statistic value (e.g., mean value, weighted mean value, median, etc.) of a plurality of current values of activeness of action of multiple people, a current value of activeness of action of one representative among multiple people, or a statistic value (e.g., mean value, weighted mean value, median, etc.) of a plurality of current values of a plurality of representatives among multiple people.

Specifically, in a case where a difference between the current value A2 of activeness and the target value A1 of activeness is a predetermined first threshold T1 or more and the current value A2 is lower than the target value A1, the controlling unit 11 controls the device 30 to obtain an environment where activeness is enhanced. Control of the device 30 to obtain an environment where activeness is enhanced is, for example, one or a combination of two or more of controls such as control of an air conditioner for increasing a temperature of the target area 60, control of an illumination device for lightening the target area 60, control of an illumination device for bringing the color of illumination light of the target area 60 toward daylight white from neutral white control of an audio device for playing fast-paced music in the target area 60, and control of electric blinds for opening window blinds, It should be noted that details of control of the device 30 for changing the environment is not limited to these examples of control or a combination of two or more of them.

The controlling unit 11 controls the device 30 to obtain an environment where activeness is reduced if the difference between the current value A2 of activeness and the target value Al of activeness is a predetermined second threshold T2 or more and the current value A2 is higher than the target value A1. The first threshold T1 and the second threshold T2 may be equal or may be different. The control of the device 30 to obtain an environment where activeness is reduced is, for example, one or a combination of two or more of the following controls: control of an air conditioner for reducing the temperature of the target area 60; control of an air conditioner, an electric fan, or a ventilator for strengthening an airflow in the target area 60, control of an aroma diffuser for providing an aroma for calming the mood to the air in the target area 60; control of an illumination device for reducing brightness in the target area 60, control of the illumination device for bringing the color of illumination light in the target area 60 closer to neutral white from daylight white; control of an audio device for playing slow, quiet music in the target area 60; and control of an electric window for opening the window. It should be noted that details of control of the device 30 for changing the environment is not limited to these examples of control or a combination of two or more of them.

FIG. 3 is a diagram illustrating an example of a hardware configuration of the device control apparatus 10 according to the first embodiment. The device control apparatus 10 is, for example, a computer. The device control apparatus 10 may be on a cloud service (cloud server). The device control apparatus 10 includes a processor 101, a memory 102, a storage 103 as a nonvolatile storage device, an interface 104, a communication unit 105, and an input unit 106. The processor 101 is, for example, a central processing unit (CPU). The memory 102 is, for example, a volatile semiconductor memory such as a random access memory (RAM). The storage 103 is a storage device such as a hard disk drive (HDD) or a solid-state drive (SSD). The storage 103 stores information and programs. The communication unit 105 communicates with other devices through a network. The input unit 106 is an operation unit such as a keyboard that is an input interface. The input unit 106 receives an input from a person. Devices such as the environment detector 40 and the physical state detector 50 are connected to the interface 104. Functions of the device control apparatus 10 may be implemented by either a plurality of computers or a computer and a cloud server.

Functions of the device control apparatus 10 are implemented by a processing circuit. The processing circuit may be a dedicated hardware or the processor 101 that performs a program stored in the memory 102. The processor 101 may be any one of processing device, computation device, a microprocessor, a microcomputer, and a digital signal processor (DSP).

In a case where the processing circuit is a dedicated hardware, the processing circuit is, for example, a single circuit, a composite circuit, a programmed processor, a parallel-programmed processor, an application specific integrated circuit (ASIC), a field-programmable gate array (FPGA), or a combination of any two or more of them.

In a case where the processing circuit is the processor 101, the device control program according to the first embodiment is implemented by software, firmware, a combination of software and firmware. The software and the firmware are written programs and stored in the memory 102. The processor 101 can perform functions of sections illustrated in FIG. 2 by reading and executing a device control program stored in the memory 102. The device control program is installed in the device control apparatus 10 by download through a network or from a recording medium (i.e., storage medium) that stores information such as an optical disk. Part of the device control apparatus 10 may be implemented by dedicated hardware and another part of the device control apparatus 10 may be implemented by software or firmware. In this manner, the processing circuit may implement functions of functional blocks illustrated in FIG. 1 by hardware, software, firmware, or a combination of these.

FIG. 4 is a diagram illustrating an example of the device 30 of the device control system 1 according to the first embodiment. The device 30 includes at least one (i.e., one or a combination) of first through fifth electric devices 31 through 35. The device 30 is connectable to a network directly or through a gateway (GW), and transmits device state information to the device control apparatus 10 through the network. The first through fifth electric devices are classified by functions, but such classification is merely an example, and another classification may be employed. For example, in a case where a robot classified as the fifth electric device has a function as an audio device, the robot is also classified as the third electric device.

The device state information indicates, for example, an operation status representing operation performed by a person, such as on or off of the device 30, a setting status representing setting of the device 30, or an operation status in which the device 30 is in operation. In this embodiment, the device state information includes at least the operation status.

The first electric device 31 adjusts an environment related to air in the target area 60. The first electric device 31 changes at least one (i.e., one or a combination) of temperature, humidity, airflow, smell, and air quality in the target area 60, for example. The airflow includes an intensity and a direction of a flow of air. The air quality is a component of air and includes a content or a concentration of at least one of nitrogen, oxygen, carbon monoxide, carbon dioxide, nitrogen oxide, fine particles such as dust, or a chemical substance such as formaldehyde. The first electric device 31 includes at least one of an air conditioner, an electric fan, a ventilator, a humidifier, an aroma diffuser, or an air cleaner, for example. A tea dispenser or a coffee maker may be used as an aromatic appliance similar to an aroma diffuser.

The second electric device 32 adjusts an environment related to brightness in the target area 60. The second electric device 32 changes at least one (i.e., one or a combination) of brightness, color, or illumination effect in the target area 60, for example. The change of brightness is a change of luminance. The change of color is a change of color of illumination light. The color includes, for example, warm white, neutral white, and daylight white. The change of illumination effect is a change of a face be illuminated, for example, uniformly illuminating the entire room, illuminating only ceiling surface, illuminating only a wall surface, illuminating only a floor surface, illuminating a wall surface and a floor surface, or Illuminating a ceiling and a wall surface. The change of illumination effect is performed by, for example, an illumination device installed in the target area 60.

The third electric device 33 adjusts an environment related to video or sound in the target area 60. The third electric device 33 provides at least one (i.e., one or a combination) of video and sound in the target area 60, for example. The third electric device 33 includes at least one of a video device such as a display device or an audio device such as an audio player. In this case, the display device can output characters, images, animation, and pictures, together with sound. The audio device can reproduce sound, voice, and music.

The fourth electric device 34 adjusts an environment related to a window or a door in the target area 60. The fourth electric device 34 performs at least one (i.e., one a combination) of opening/closing of a window, opening/closing of a window blind, or opening/closing of a door in the target area 60. The fourth electric device 34 includes at least one of an electric window that opens and closes by electric power, an electric door that opens and closes by electric power, or an electric blind (i.e., electric curtain) that opens and closes by electric power.

The fifth electric device 35 is a robot placed in the target area 60. A healing robot or an animal robot enables to calm an excited state of a person through an action, speech, or the like. In addition, a robot that supports a person or a robot that cheers a person enables to encourage a person in a depressed state through an action, speech, or the like.

FIG. 5 is a diagram illustrating an example of the environment detector 40 of the device control system 1 according to the first embodiment. The environment detector 40 includes at least one (i.e., one or a combination) of first through fourth environment sensors 41 through 44. The environment detector 40 is connectable to a network, and transmits environment information B0 to the device control apparatus 10 through the network. The environment information B0 can include device state information indicating a state of the device 30. The first through fourth environment sensors may be independent of each other or may be part of the device. A plurality of environment sensors may be configured as one unit.

The first environment sensor 41 detects an environment related to air in the target area 60. The first environment. sensor 41 detects, for example, at least one (i.e.) one or a combination) of temperature, humidity, airflow, smell, or air quality in the target area 60. The first environment sensor 41 includes at least one of a thermal image sensor, a human detection sensor, a temperature sensor, a humidity sensor, an airflow direction sensor, an airflow rate sensor, or an air quality sensor.

The second environment sensor 42 detects an environment related to brightness of the target area 60. The second environment sensor 42 detects at least one (i.e., one or a combination) of brightness, color, or illumination effect in the target area 60, for example. The second environment sensor 42 includes at least one of a luminance sensor, a camera, detection unit of a device state of an illumination device.

The third environment sensor 43 detects an environment related to video or sound in the target area 60. The third environment sensor 43 detects at least one (i.e., one or a combination) of video or sound provided in the target area 60, for example. The third environment sensor 43 includes a detection unit for detecting a device state of a video device or an audio device.

The fourth environment sensor 44 detects an environment related to a window or a door in the target area 60. The fourth environment sensor 44 detects, for example, at least one (i.e.) one or a combination) of an opening/closing state of a window, an opening/closing state of a window blind, or an opening/closing state of a door in the target area 60. The fourth environment sensor 44 includes a detection unit for detecting at least an opening/closing state of a window, an opening/closing state of a window blind, or an opening/closing state of a door.

FIG. 6 is a diagram illustrating an example of the physical state detector 50 of the device control system 1 according to the first embodiment. The physical state detector 50 includes at least one of first through fourth physical state sensors 51 through 54.

The first physical state sensor 51 detects mainly vital signs in physical states of multiple people. The first physical state sensor 51 detects at least one (i.e., one or a combination) of heart beats, respirations, body temperatures, blood pressures of multiple people. The first physical state sensor 51 includes, for example, a vital sensor and a thermal image camera. The first physical state sensor 51 is, for example, wearable device or a non-contact vital sensor. The first physical state sensor 51 may include a brain wave sensor,

The controlling unit 11 can calculate activeness (e.g., excitement level or relax level) of each action of people in the target area 60, from physical state information such as heart rate, respiration rate, heartbeat interval, a Low frequency/respiratory frequency (LF/RF) calculated from a heartbeat interval, or an R-R interval (RRI), for example. The heartbeat interval RRI is an interval between an R wave and an R wave, and an average or a standard deviation of RRI is an index of stress estimation.

For example, this is known to correspond to Mayer waves that are a blood pressure fluctuation E_{L} in a region of a low-frequency (LF) component of a power spectrum (i.e., from 0.05 Hz to 0.15 Hz), and correspond to a respiration fluctuation F_{H} in a region of a high-frequency (HF) component the power spectrum (i.e., from 0.15 Hz to 0.40 Hz). In this embodiment, a time integral value of fluctuation E_{L}/F_{H} is usable as a stress index indicating a sympathetic nerve activity (also referred to as an “LH/HF index”) Such a stress index is usable as activeness of action of each person. In this manner, the controlling unit 11 can estimate activeness by determining whether parasympathetic nerve becomes active or not (i.e., whether a relax level increases or not) using an evaluation method by Lorenz plot of the heartbeat interval RRI. The controlling unit 11 may calculate activeness from a sensed person state other than heart rate, respiration rate, and heartbeat interval.

The second physical state sensor 52 detects motions of mainly the entire bodies or body parts (e.g., hand, foot, neck, etc.) in physical states of multiple people. The second physical state sensor 52 includes, for example, camera, distance measuring sensor such as an LiDAR.

The third physical state sensor 53 detects at least one (i.e., one of combination) of mainly voice volumes, voice pitches, or speech speeds among physical states of multiple people. The third physical state sensor 53 includes, for example, a microphone and a voice emotion recognition tool (e.g., software program) that recognizes emotion (e.g., excitement level or relax level) from voice.

The fourth physical state sensor 54 detects at least one of mainly facial expressions or pupils of multiple people among physical states of multiple people. The fourth physical state sensor 54 includes, for example, a face photographing camera and a facial expression emotion recognition tool (e.g.) software program). The fourth physical state sensor 54 estimates emotion (e.g., excitement level or relax level) of people based on facial expressions and pupils of people. The fourth physical state sensor 54 is, for example, smart glasses that are glass-type sensors.

The controlling unit 11 can calculate activeness of action of a person based on one of or a combination of two or more of facial expression, pupils, posture, voice volume, voice pitch, speech speed, body motion, body temperature, and acceleration. In a case where attribute information of a person is acquired (e.g., an input is received from an input unit), the controlling unit 11 can also estimate activeness of the person in consideration of attributes of the person such as sex and age of the person. For example, in the case of younger people, the average heart rate, the average respiration rate, or both of these average values are high. In the case of older people, the average heart rate and the average respiration rate are low. Female voices generally tend to have a higher pitch than male voices. The accuracy in calculating activeness can be enhanced by collecting and storing attribute data of people in advance and performing correction based on attributes.

FIG. 7 is a diagram showing an example of activeness distribution. In FIG. 7, the horizontal axis represents activeness, and the vertical axis represents the number of people. The controlling unit 11 uses a mean value of a median of activeness individually calculated as activeness of action of participants of a meeting. The controlling unit 11 can also calculate activeness based on a weighted sum of activeness in which the number of multiple people contributing activeness is used as a weighing factor.

The controlling unit 11 may dynamically change a target by receiving feedback from the physical state detector 50 and the environment detector 40. That is, the controlling unit 11 controls the device 30 to provide an environment suitable for a target state acquired by the target acquiring unit 12 to thereby enable participants of a meeting to obtain a useful conclusion through active discussions or through avoidance of occurrence of an excessively excited person.

### <1-2> Operation

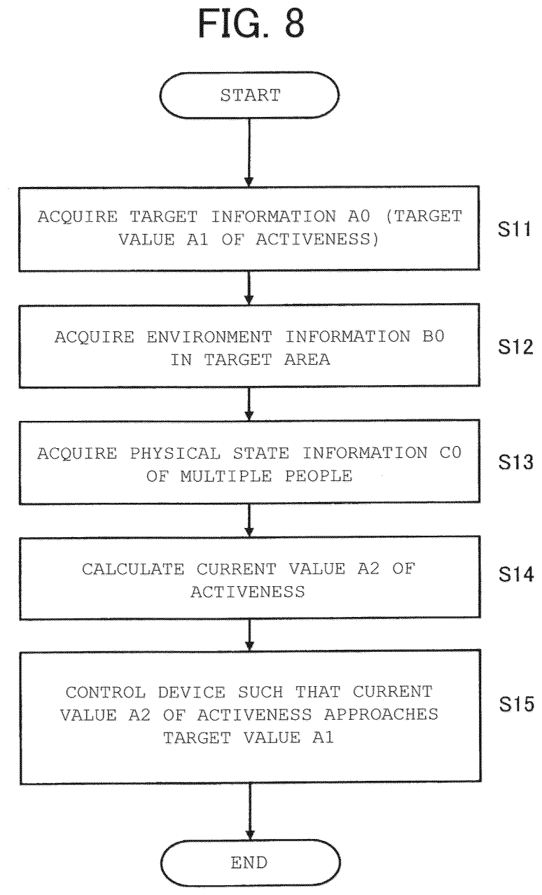

FIG. 8 is a flowchart showing a process of the device control apparatus 10 according to the first embodiment. First, the controlling unit 11 acquires target information A0 (e.g., target value A1) indicating a target state of action of multiple people in the target area 60 through the target acquiring unit 12 (step S11). Next, the controlling unit 11 acquires environment information B0 indicating a state of an environment of the target area 60 including multiple people, from the environment information acquiring unit 13 (step S12). Thereafter, the controlling unit 11 acquires physical state information C0 indicating physical states of multiple people from the physical state information acquiring unit 14 (step S13). The order of steps S11 through S13 is not limited to the order shown in FIG. 8 and may be another order.

Subsequently, the controlling unit 11 calculates a current value A2 of activeness from the physical state information C0. Then, the controlling unit 11 controls the device 30 to obtain an environment where the current value A2 of activeness approaches the target value A1.

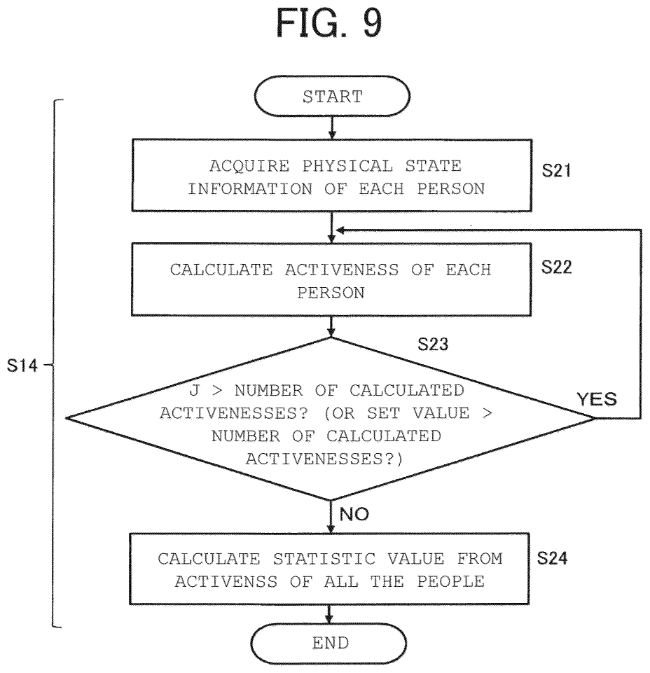

FIG. 9 is a flowchart showing a calculation process (step S14) of the current value A2 of activeness in FIG. 8. First, the controlling unit 11 acquires physical state information Co of each person (step S21). Next, the controlling unit 11 calculates activeness (i.e., current value of activeness) of each person based on the physical state information C0.

Then, the controlling unit 11 determines whether the number of calculated activenesses (i.e., current values of activeness) is smaller than the number J of multiple people in the target area 60, and if the number of calculated activenesses is smaller than the number J (YES in step S23), the process returns to step S22, and activeness of another person is calculated. If the number of calculated activenesses (.e., current values of activeness) is greater than or equal to the number J (NO in step S23), the controlling unit 11 proceeds to step S24. The number J is the number of people input from the input unit beforehand or the number of people detect based on a camera image. A threshold to be used for determination in step S23 may be set to another value such as half the number o of multiple people in the target area 60. This is because even if activenesses of all the people in the target area 60 are not calculated, it is possible to estimate activeness of the entire people with activenesses of some people. In addition, it is considered that if there is a person in a particularly excited state, this person may affect others around the person and the overall activeness may be increased. Therefore, the device may be controlled to reduce the activeness if there are one or more people with abnormally high activeness (i.e. if an activeness threshold is set to detect an extremely excited person and there are one or more people with activeness exceeding this threshold).

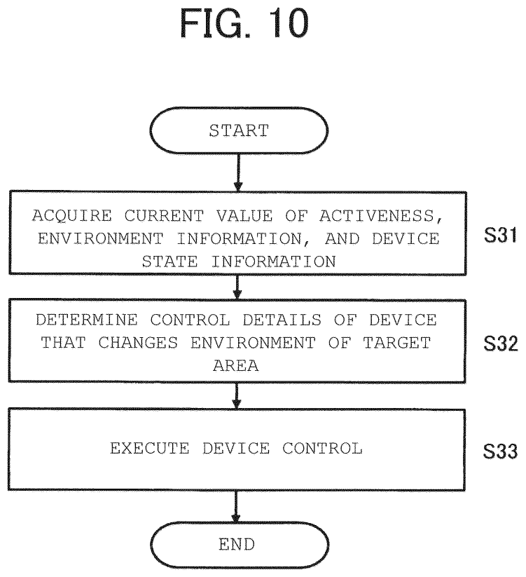

FIG. 10 is a flowchart showing control of the device 30 of the device control apparatus 10 according to the first embodiment. The controlling unit 11 determines control details of the device 30 to change an environment in the target area 60 from the current value of activeness, environment information, and device state information (that may be acquired as environment information) (steps S31 and S32). Then, the controlling unit 11 controls the device 30 in accordance with the determined control details,

### <1-3> Advantages

As described above, according to the first embodiment, states of multiple people in the target area 60 can approach a target state. For example, according to the first embodiment, the device 30 can be controlled to lower activeness (i.e., calm participants of a meeting) if activeness of actions of the participants of the meeting becomes too high and the discussion becomes overly heated, or to raise activeness (i.e., energize the participants) if the meeting becomes too quiet,

The activeness described above may include information other than numerical values, For example, the activeness may be provided with information indicating coordinates or a range specified by a two-dimensional region (or three-dimensional space) in the target area 60. That is, information indicating activeness of action of participants of the meeting may be set to different values for places in the target area 60.

### <1-4> First Variation

Next, a device control system according to a first variation of the first embodiment will be described. The first variation describes a case where the target area 60 is a public place (e.g., inside a train, shopping mall, a school, hospital, etc.) used by multiple people. In public spaces used by multiple people, a low activeness state is often required as a target state of multiple people so that the multiple people can maintain a calm atmosphere. In the first variation, an example in which the target area 60 is a public space used by multiple people, target people are multiple people gathering in the public space, and a low activeness state is set as a target state. Description of the first variation will be given with reference to FIGS. 1 through 6.

In the device control system according to the first variation, regarding multiple people (that may be a small number of representatives among the multiple people) in a public space as the target area 60, a change of voice, motion of the body, or both of them are detected, and based on the detection result, physical state information of people in the target area 60 is acquired, and activeness of people in the target area 60 is detected based on this physical state information.

The device control system according to the first variation controls operation of the device 30 to bring the states of multiple people in the target area 60 toward the target state in a case where the multiple people in the target area 60 include a person whose voice has suddenly increased in volume (e.g., a person determined to be in an excited state based on loudness of voice), a person who has suddenly become excited (e.g., person determined to be in an excited state based on vigorous physical movement), or people in both of these conditions.

Specifically, to people in the target area 60, the device control system according to the first variation performs “application of a strong stimulus to make the people aware that they are in an excited state” (application of a first stimulus) as a first stage, and performs “application of a stimulus to alleviate the excited state and calm the people” (application of a second stimulus different from the first stimulus) as a second stage.

Examples of application of the stimulus in the first stage include suddenly releasing cold air from an air conditioner toward the people in the target area 60 (e.g.) air at a temperature lower than room temperature by a preset temperature), emitting startling loud sound (e.g., a siren or warning sound) from an audio device toward the people in the target area 60, emitting startling strong Light (e.g., momentarily flashing light) from an illumination device toward the people in the target area 60, and the like. The application of the stimulus in the first stage may be a combination of two or three of suddenly releasing cold air, emitting startling loud sound from the audio device, and emitting startling strong light from the illumination device.

Examples of application of the stimulus in the second stage include outputting music with a calming effect on people from an audio device toward the people in the target area 60, releasing calming scents from an aroma diffuser toward the people in the target area 60, outputting video with a calming effect on people from a video device toward the people in the target area 60, and the like. The application of the stimulus in the second stage may be a combination of two or three of outputting music, releasing scents, and outputting video.

As described above, the device control system according to the first variation of the first embodiment can effectively perform application of a stimulus to bring states a large number of unspecified people (e.g., state of an excited person) in the target area 60 that is a public space such as in a train, a shopping mall, a school, or a hospital closer to a target state (e.g., low activeness state).

### <1-5> Second Variation

Next, a device control System according to a second variation of the first embodiment will be described. The second variation describes a case where the target area 60 is a public space used by multiple people (e.g., an event venue, such as a concert venue, a movie theater, a theater, and a stadium). In concert venues (e.g., inside or outside of buildings where live concerts are held), movie theaters, theaters, sports stadiums, for example, a high activeness state is often requested as a target state of multiple people to maintain feelings of elation and openness of the multiple people. In some situations provided in the target area 60 (e.g., details of musical pieces, videos, performance, competitions), a low activeness state is sometimes required as a target state of multiple people in a public space to suppress activeness of the multiple people in the public space. In the example of the device control system according to the second variation, the target area 60 is a public space used by multiple people, target people are multiple people gathering in the public space, and a high activeness state is set as a target state. The following description will be given with reference to FIGS. 1 through 6.

The device control system according to the second variation detects a change in sound (e.g., cheering, applause, claps) made by people in a public space that is the target area 60, physical movements (e.g., standing up, raising hands, dancing, etc.), or both, and based on a detection result, acquires physical state information of multiple people in the target area 60, and detects activeness of multiple people in the target area 60 based on the physical state information.

The device control system according to the second variation controls operation of the device 30 to bring states of multiple people in the target area 60 closer to a target state in a case where states of the multiple people in the target area 60 (that may be states of representatives, a small number of people among the multiple people) are determined neither as an uplifted state (i.e., high activeness state) nor as a state of feeling open (i.e., high activeness state). Specifically, the device control system according to the second variation is expected to enhance enjoyment of an event by releasing invigorating scents (e.g., cool and refreshing stimulating scent, or both of these scents) from an aroma diffuser toward multiple people in the target area 60, by flowing, toward multiple people in the target area 60, an air low at a humidity that can make them feel comfortable and a low temperature that can make them feel cool, by using an air blower, a humidifier, or an air conditioner, or by employing both of these.

As described above, the device control system according to the second variation of the first embodiment can enhance enjoyment of the people in the target area 60 by applying a stimulus for bringing states (e.g., low activeness states) of a large number of unspecified people in the target area 60 that is a public space closer to a target state (e.g., low activeness state). In addition, the device control system according to the second variation of the first embodiment can enhance enjoyment of the people in the target area 60 by controlling a stimulus for bringing states (e.g., high activeness states) of a large number of unspecified people in the target area 60 that is a public space closer to a target state (e.g., low activeness state) (e.g., control by changing the type of or stopping a scent provided, control by weakening or stopping an airflow provided, or control of both scent and airflow).

### <1-6> Third Variation

In the first embodiment and the first and second variations of the first embodiment, to reduce activeness of multiple people in the target area 60, a quiet and warm scene can be recreated with an illumination device, a video device, and an air conditioner. For example, it is said that people feel calm near a campfire. In view of this, a device control system according to a third variation of the first embodiment can make a person feel an environment near a campfire to effectively reduce activeness of the person by combining two or more of sound of a campfire through a speaker, flickering Light simulating campfire projected by an illumination device, warm air sent from an air conditioner, and a scent released from an aroma diffuser. That is, although such simulation of an environment is difficult by controlling a single device, controlling multiple devices in combination makes it possible to simulate a specific environment and effectively calm an excited person (i.e., person whose activeness is greater than or equal to a threshold).

### <1-7> Fourth Variation

In the first embodiment and the first through third variations of the first embodiment, to reduce activeness of multiple people in the target area 60, a quiet and cool scene can be recreated with an illumination device, a video device, and an air conditioner. For example, it is said that people feel relaxed and calm in an environment with flowing water, such as near a waterfall or fountain. A device control system according to a fourth variation of the first embodiment can cause a person to feel an environment near water (e.g., environment near a waterfall, an environment with a fountain, an environment with a stream, an environment during rain, an environment with sound of waves on a seashore, etc.) to effectively reduce activeness of the person by combining two or more of sound of water through a speaker, cool and moderately humidified air sent from an air conditioner, and bluish light projected from an illumination device. That is, although simulation of such an environment is difficult by controlling a single device, multiple devices are combined and controlled to simulate a specific environment so that an excited person (i.e., person whose activeness has become greater than or equal to a threshold) can be thereby effectively calmed.

### <1-8> Fifth Variation

In the description of the first embodiment and the first through fourth variations of the first embodiment, activeness of multiple people in the target area 60 may be replaced by activeness of small number of representatives among the multiple people. A fifth variation of the first embodiment describes a case requiring control tailored these representatives who are predetermined people among multiple people (e.g., people whose physical information is to be detected with priority based on sex, whether they are children or adults, whether the adults are elderly, estimated height, body shape, closing, the amount or type of belongings they are carrying, etc.), that is, people with high priority.

In the device control system according to the fifth variation, a person who is feeling unwell or in a bad mood among multiple people in the target area 60 is detected based on voice or behavior and the detected person is set as a person with high priority for monitoring. This is because such a person with high priority easily affects others around the person, and might degrade physical conditions of others or irritates others. For example, if a person in multiple people is in a poor physical condition or has a bad mood, this state can spread to others to deteriorate physical or mental states of many people in the target area 60 and worsen the atmosphere in the target area 60. To avoid such a situation, the device control system according to the fifth variation spec les a person who appears to be in the worst physical condition or in the worst mood from multiple people in the target area 60 based on voice or behavior, sets the specified person as a person with high priority, and controls the device to create an environment where the person with high priority can maintain a comfortable physical or mental state. In this manner, the resulting advantage of enhancing states of people in this place is expected.

### <1-9> Sixth Variation

In the first embodiment and the first through fifth variations of the first embodiment, activeness of multiple people. for representatives) in the target area 60 is detected mainly based on voice of people, action of people, or a combination thereof. A device control system according to a sixth variation of the first embodiment performs detection of activeness of multiple people (or representatives) in the target area 60 based on internal body information as vital signs of individuals (e.g., brain waves, heart rates, body temperatures, blood pressures, etc.), external body information such as posture and movement (e.g., slouched posture, trembling movement, motionless posture, silent state, direction gaze, etc.), and weather information (e.g., weather, atmospheric pressure, etc.) or a combination of two or more of information sets. The device control system according to the sixth variation of the first embodiment detects that a physical or mental state of a specific person is poor and controls the device to thereby recreate an environment where the specific person was in a good physical or mental state. For example, the device control system according to the sixth variation can recreate an environment where a physical or mental state of a specific person was good by adjustment of temperature and humidity with an air conditioner, adjustment of luminance with an illumination device, adjustment of color temperature with an illumination device, adjustment of output sound with an audio device, adjustment of a display image with a video device, or a combination of these adjustments.

### <1-10> Seventh Variation

In the first embodiment and the first through sixth variations of the first embodiment, an environment where physical or mental state of a specific person is improved is created by controlling the devices to thereby control activeness of people in the target area 60. A seventh variation of the first embodiment describes an example in which a poor physical or mental state of a person is due to irregular lifestyle, restricted outdoor activity (leading to a lack of exercise), insufficient sleep, and accumulated fatigue, and so forth. The device control system according to the seventh variation of the first embodiment can estimate factors of poor physical or mental states of multiple people by prior assessments (e.g., assessments such as medical examinations or health checkup) in a case where living conditions of multiple people in the target area 60 can be known (e.g., a case where the multiple people are attending or working at a hospital or a case where the multiple people are attending or working at a school, etc.), for example. In such a case, the device control system according to the seventh variation can use robot, an audio device, and a video device to recreate an environment surrounding multiple people in the target area 60 to thereby enable reduction of increase of activeness of multiple people. The device control system according to the seventh variation can recreate an environment closely similar to a real indoor or outdoor environment by combining adjustment of temperature and humidity of an airflow generated by an air conditioner and adjustment of luminance and color with an illumination device.

In a case where a poor physical or mental state of a person is due to insufficient sleep, accumulated fatigue, and so forth, the device control system according to the seventh variation can provide a sense of rest to people in the target area 60 by adjusting temperature and humidity of an airflow generated by an air conditioner, adjusting to reduce illuminance of lighting with an illumination device, bringing a color temperature of lighting with an illumination device closer to warm color temperatures, providing music with an audio device, providing an image with a video device, or combining some of these adjustments.

### <2> Second Embodiment

### <2-1> Configuration

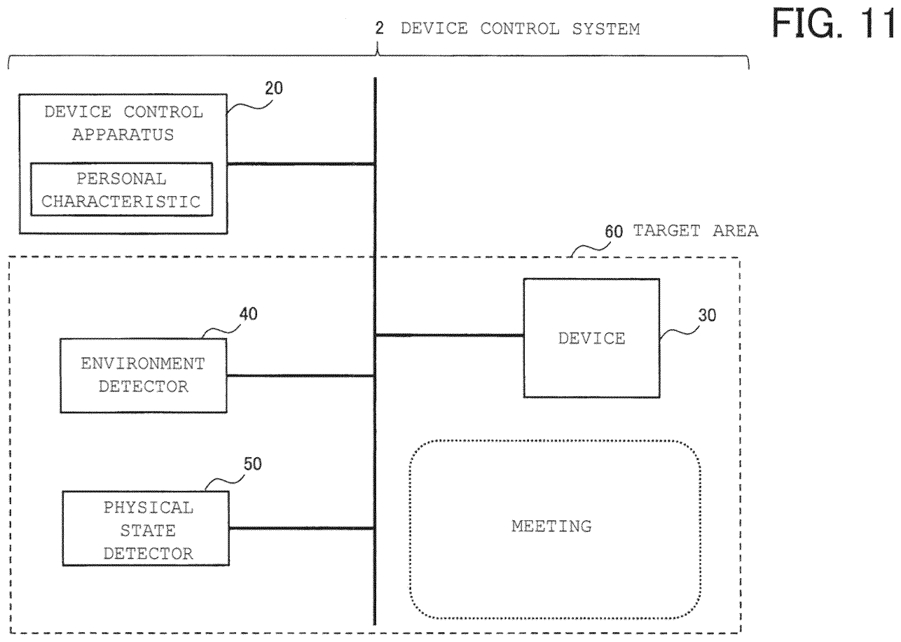

FIG. 11 is a block diagram schematically illustrating a configuration of a device control system 2 according to a second embodiment. In FIG. 11, the same reference characters as those in FIG. 1 designate the same or corresponding components as those illustrated in FIG. 1. The device control system 2 is different from the device control system 1 according to the first embodiment in that a device control apparatus 20 acquires personal characteristic information indicating attributes of multiple people in a target area 60.

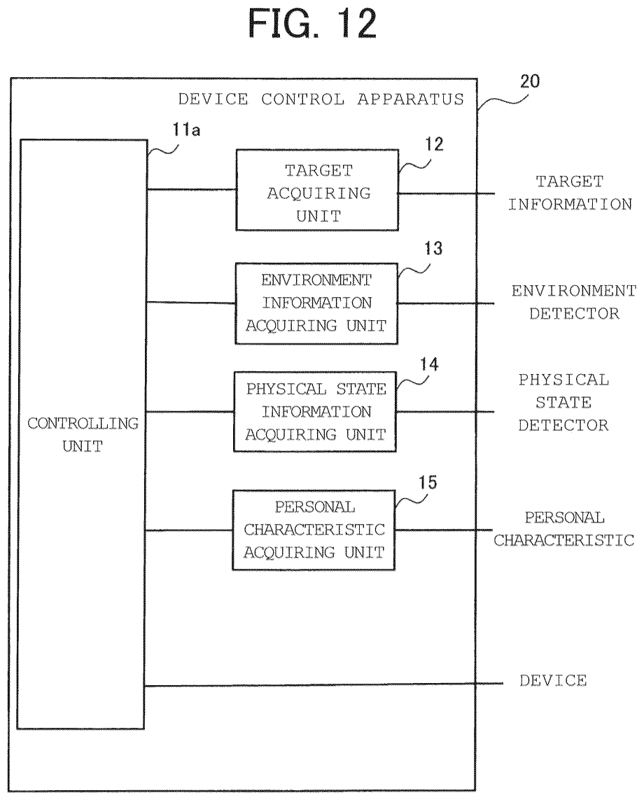

FIG. 12 is a block diagram schematically illustrating a configuration of the device control apparatus 20 according to the second embodiment, In FIG. 12, the same reference characters as those in FIG. 2 designate the same or corresponding components as those illustrated in FIG. 2. The device control apparatus 20 is different from the device control apparatus 10 according to the first embodiment in including a target acquiring unit 12, an environment information acquiring unit 13, and a personal characteristic acquiring unit 15 and in details of control of a controlling unit 11a.

The personal characteristic acquiring unit 15 acquires characteristic information (also referred to as “character information”) defining individual characters. The individual characters are, for example, Big Five personality traits. The Big Five personality traits are also a five-factor model, and represent characters (personality) using five parameters of openness, diligence, extraversion, cooperativeness, and neuroticism. That is, it is sufficient to include characteristic information in any of the five parameters, Big Five personality traits are described in, for example, Non-patent Reference 1.
[Non-patent Reference 1] Oliver P. John, Laura P. Naumann, and Christopher J. Soto, “Paradigm shift to the integrative big five trait taxonomy: History, measurement, and conceptual issues”, Handbook of personality: Theory and search, 3.2 edition, Guilford Press, (2008), pp. 114-158

Openness represents a degree to which a person prefers new experience of diversity and can also be referred to as openness to experience. Diligence represents a degree to which a person is ambitious and achievement-oriented or has a preference for planned behavior, and can also be referred to as integrity. Extraversion represents a degree to which a person prefers keeping company having conversations with others. Cooperativeness represents a degree of tendency to which a person is cooperative with others, and can also be referred to as harmony or attachment. Neuroticism represents a degree of tendency to which a person has a stable personality and is less likely to experience unpleasant emotions, conversely, this trait can also be referred to as neurosis tendency.

The character information may include a parameter representing a strength of self-control as an element. The self-control is described in, for example, Non-patent Reference 2.
[Non-patent Reference 2] June P. Tangney, Roy F, Baumeister, and Angie Luzio Boone, “High Self-Control Predicts Good Adjustment, Less Pathology, Better Grades, and Interpersonal Success”, Journal of Personality 72:2, (2004), pp. 271-324

Self-control refers to pursuit of desirable action and suppression of undesirable action through one's own will when a person faces with temptation or impulses. Character information may include other parameters that have established definitions and measurement methods in the field of psychology. When there are multiple people using the device 30, it is preferable to have character information for each of those people.

It is sufficient for the personal characteristic acquiring unit 15 to acquire character information obtained by performing questionnaire concerning characters to people. The questionnaire may be conducted with an input unit 106 or may be conducted face-to-face at purchase of the device 30. The personal characteristic acquiring unit 15 may acquire scores on a personality scale already measured from a communication unit 105 through a network or the like, or through an input by a person.

The character information may be obtained through a network or the like from data estimated based on an operation history of a “Like button” that is a button-type interface in a social network service (SNS) or a posting history. Such an acquisition method for character information is described in, for example, Non-patent Reference 3.
[Non-patent Reference 3] Wu Youyou, Michal Kosinski, and David Stillwell, “Computer-based personality judgments are more accurate than those made by humans”, Proceedings of the National Academy of Sciences 112.4 (2015), pp. 1036-1040

In addition, the character information may also be acquired through a network or the like as data estimated based on an operation history, an activity history, or stored contents of a device such as a smartphone. This estimation method is described in, for example, Non-patent Reference 4.
[Non-patent Reference 4] Clemens Stachl et al. “Predicting personality from patterns of behavior collected with smartphones,” Proceedings of the National Academy of Sciences 117.30 (2020), pp. 17680-17687

The device for use in acquiring character information may be the same device as or a device different from a wearable device or a non-contact vital sensor connected to the physical state information acquiring unit 14.

The controlling unit 11a determines a personal characteristic based on character information acquired by the personal character The controlling unit 11a may determine character information based on a device operation and an activity history of the device. Character information is estimated from device operation using a correlation between Big Five personality traits of character information and preference in device operation. An example will be described below.

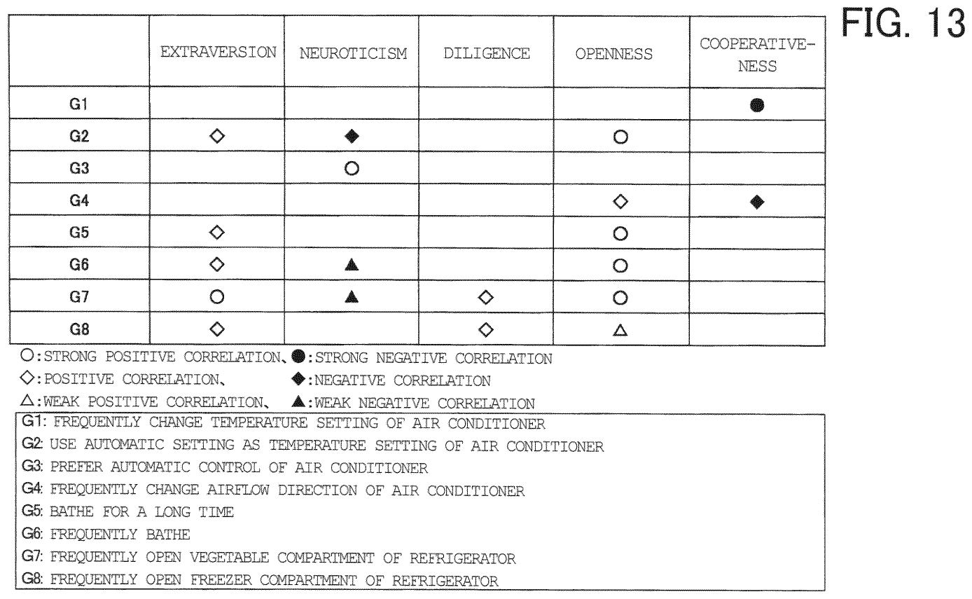

FIG. 13 is a table showing an example of a correlation between Big Five personality traits and operation of a household electrical appliance. FIG. 13 shows an example of a correlation between operation or activity history of a household electrical appliance such as an air conditioner, a heat pump water heater used for bathing, a refrigerator and Big Five personality traits, A positive or negative correlation is found between Big Five personality traits and device operation, and thus, character information can be estimated from the device operation or an activity history.

For example, FIG. 13 shows the following examples (G1) through (G8) in a table form.
(G1) A strong negative correlation is observed between a person who frequently sets a temperature of an air conditioner (g1) and cooperativeness.
(G2) A strong positive correlation is observed between a person who uses automatic setting as a temperature setting of the air conditioner (g2) and openness (i.e., character receptive to a new function), a negative correlation is observed between the person (g2) and neuroticism (i.e., character sensitive to temperature change), and a positive correlation is observed between the person (g2) and extraversion.
(G3) A strong positive correlation is observed between a person who prefers automatic control of the air conditioner (g3) and neuroticism.
(G4) A positive correlation is observed between a person who frequently changes an airflow direction of the air conditioner (g4) and openness, and a negative correlation is observed between the person (g4) and cooperativeness.
(G5) A strong positive correlation is observed between a person who bathes for a long time (g5) and openness, and a positive correlation is observed between the person (g5) and extraversion.
(G6) A strong positive correlation is observed between a person who frequently bathes (g6) and openness, and a positive correlation is observed between the person (g6) and extraversion.
(G7) A strong positive correlation is observed between a person who frequently opens a vegetable compartment of a refrigerator (g7) and extraversion, a strong positive correlation is observed between the person (g7) and openness, a positive correlation is observed between the person (g7) and diligence, and a weak negative correlation is observed between the person (g7) and neuroticism.
(G8) A weak positive correlation is observed between a person who frequently opens a freezer compartment of a refrigeration (g8) and extraversion, a weak positive correlation is observed between the person (g8) and openness, and a positive correlation is observed between the person (g8) and diligence.

In calculating a current value of activeness of action of participants of a meeting, the controlling unit 11a performs correction in accordance with character information acquired by the personal characteristic acquiring unit 15. For example, a person with high cooperativeness has a high degree of tendency of acting in harmony with others, and thus, activeness of action is less likely to change. A person with high extraversion is more likely to exhibit significant change in activeness of action. A person with high neuroticism tends to change activeness of action.

In determining a target value of activeness, the controlling unit 11a performs correction based on character information. A target value of activeness of the overall action of multiple people in the target area 60 is adjusted based on the type of personal characteristic thereof. For example, in a case where participants of a meeting include a large number of people with high cooperativeness (i.e., people showing small fluctuation of activeness), the controlling unit 11a adjusts the target level of activeness to a relatively large value for setting. In a case where the participants of the meeting include a large number of people with high extraversion (i.e., people exhibiting large fluctuation of activeness), the controlling unit 11a adjusts the target value of activeness to a relative low value for setting. In a case where the participants of the meeting include a large number of people with high neuroticism (i.e., people exhibiting significant fluctuation of activeness), the controlling unit 11a adjusts the target value of activeness to a value close to a current value of activeness for setting.

### <2-2> Operation

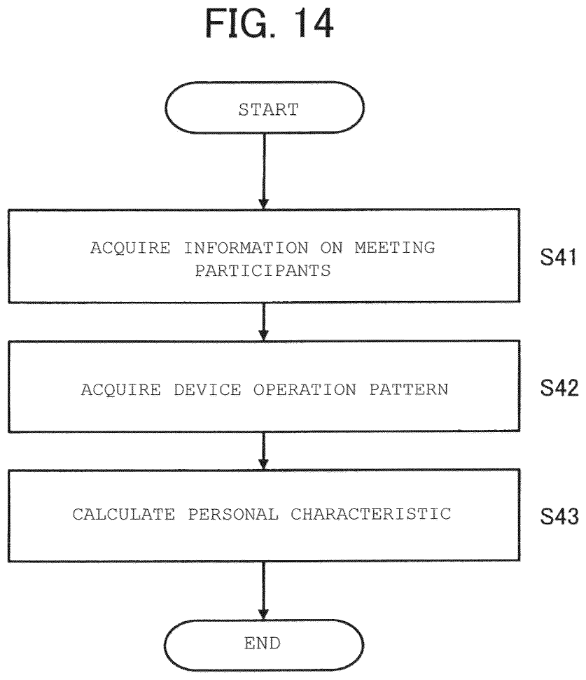

FIG. 14 is a flowchart showing calculation of personal characteristics by the device control apparatus 20 according to the second embodiment. First, the controlling unit 11a acquires attributes concerning a person and a person detection value that is a physical quantity detected from a person as person information through the physical state information acquiring unit 14 and the communication unit 105 (step S41). The acquired person information is given to the personal characteristic acquiring unit 15. A device operation pattern of an expected participant of a meeting stored in a storage 103 is referenced (step S42).

The controlling unit 11a calculates personal a personal characteristic from attributes from the physical state information acquiring unit 14 or from the device operation pattern (step S43).

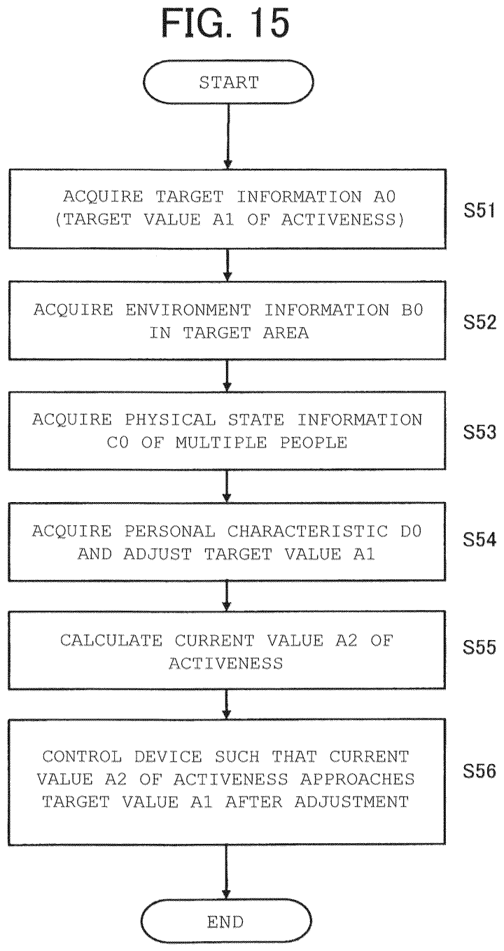

FIG. 15 is a flowchart showing a process of the device control apparatus 20 according to the second embodiment. First, the controlling unit 11a acquires target information A0 (e.g., target value A1) indicating a target state of action of multiple people in the target area 60 through the target acquiring unit 12 (step S41). Next, the controlling unit 11 acquires environment information B0 (including machine state information) indicating a state of an environment of the target area 60 including multiple people, from the environment information acquiring unit 13 (step S42). Thereafter, the controlling unit 11a acquires physical state information C0 indicating physical states of multiple people from the physical state information acquiring unit 14 (step S43). Then, the controlling unit 11a acquires a personal characteristic D0 indicating character information of multiple people from the personal characteristic acquiring unit 15, and adjusts a target value A1 of activeness depending on the personal characteristic D0 (step S44). The order of steps S41 through S44 is not limited to the order shown in FIG. 14 and may be another order.

Subsequently, the controlling unit 11a calculates a current value A2 of activeness From the physical state information C0. Then, the controlling unit 11a controls the device 30 to obtain an environment where the current value A2 of activeness approaches the target value A1 after adjustment.

### <2-3> Advantages

As described above, according to the second embodiment, states of multiple people in the target area 60 can approach a target state with higher accuracy. For example, by dynamically changing a target value of activeness depending on personal characteristics, the device 30 can be controlled to lower activeness (i.e., calm participants of a meeting) if activeness of the participants is too high and the discussion becomes overly heated, or activeness (i.e., energize the participants) if the meeting becomes too quiet.

Regarding the other aspects, the second embodiment is the Same as the first embodiment.

### DESCRIPTION OF REFERENCE CHARACTERS

1, 2 device control system, 10, 20 device control apparatus, 11 controlling unit, 12 target acquiring unit, 13 environment information acquiring unity 14 physical stats information acquiring unit, 15 personal characteristic acquiring unit, 30 device, 31 first electric device, 32 second electric device, 33 third electric device, 34 fourth electric device, 40 environment detector, 41 first environment sensor, 42 second environment sensor, 43 third environment sensor, 44 fourth environment sensor, 50 physical state detector first physical state sensor, 52 second physical state sensor, 53 third physical state sensor, 54 fourth physical state sensor, 60 target area, 101 processor, 102 memory, 103 storage, 104 interface, 105 communication unit, 106 input unit, A0 target information, B0 environment information, C0 physical state information.

1. A device control system comprising:
a device that changes an environment of a target area;
an environment detector that detects a state of the environment;
a physical state detector that detects a physical state of a person; and
a device control apparatus, wherein the device control apparatus includes
target acquiring circuitry that acquires target information indicating a target state of action of multiple people in the target area,
environment information acquiring circuitry that acquires environment information indicating a state of the environment of the target area including the multiple people, from the environment detector,
physical state information acquiring circuitry that acquires physical state information indicating physical states of the multiple people, from the physical state detector, and
controlling circuitry that controls the device such that states of action of the multiple people approach the target state, based on the target information, the environment information, and the physical state information,
the device control apparatus determines the target information based on input operation, which is performed in order to change atmosphere of a place in the target area. of the person and sets the atmosphere of the place, which is adjusted by the device, to the target state.

2. The device control system according to claim 1, wherein
the target acquiring circuitry acquires the target information indicating the target state of the action as a target value indicating a level of activeness of the action of the multiple people, and
the controlling circuitry calculates a current value indicating a level of activeness of the action of the multiple people based on the physical state information, and controls the device to obtain the environment where the current value approaches the target value.

3. The device control system according to claim 2, wherein
the controlling circuitry controls the device to obtain the environment where the activeness is enhanced if a difference between the current value and the target value is a predetermined first threshold or more and the current value is lower than the target value.

4. The device control system according to claim 2, wherein
the controlling circuitry controls the device to obtain the environment where the activeness is reduced if a difference between the current value and the target value is a predetermined second threshold or more and the current value is higher than the target value.

5. The device control system according to claim 2, wherein
the activeness of the action of the multiple people is a value calculated from activeness of action of each of the multiple people.

6. The device control system according to claim 2, further comprising
personal characteristic acquiring circuitry that acquires characteristic information indicating personal characteristics of the multiple people, wherein
the activeness of the action of the multiple people is determined depending on the personal characteristics of the multiple people.

7. The device control system according to claim 1, wherein
the device includes at least one of first through fourth electric devices,
the first electric device changes at least one of temperature, humidity, airflow, smell, or air quality,
the second electric device changes at least one of brightness, color, or illumination effect in the target area,
the third electric device provides at least one of video or sound in the target area, and
the fourth electric device performs at least one of opening/closing of a window, opening/closing of a window blind, or opening/closing of a door in the target area.

8. The device control system according to claim 7, wherein
the first electric device includes at least one of an air conditioner, an electric fan, a ventilator, a humidifier, an aroma diffuser, or an air cleaner,
the second electric device includes an illumination device,
the third electric device includes at least one of a video device or an audio device, and
the fourth electric device includes at least one of an electric window, an electric door, or an electric blind.

9. The device control system according to claim 1, wherein
the environment detector includes at least one of first through fourth environment sensors,
the first environment sensor detects at least one of temperature, humidity, airflow, smell, or air quality in the target area,
the second environment sensor detects at least one of brightness, color, or illumination effect in the target area,
the third environment sensor detects at least one of video or sound provided in the target area, and
the fourth environment sensor detects at least one of an opening/closing state of a window, an opening/closing state of a window blind, or an opening/closing state of a door in the target area.

10. The device control system according to claim 1, wherein
the environment detector is part of the device.

11. The device control system according to claim 1, wherein
the physical state detector includes at least one of first through fourth physical state sensors,
the first physical state sensor detects at least one of heart rates, respiration rates, body temperatures, or blood pressures of the multiple people,
the second physical state sensor detects motion of the multiple people,
the third physical state sensor detects at least one of voice volumes, voice pitches, or speech speeds of the multiple people, and
the fourth physical state sensor detects at least one of facial expressions or pupils of the multiple people.

12. A device control apparatus that controls a device for changing an environment of a target area, the device control apparatus comprising:
target acquiring circuitry that acquires target information indicating a target state of action of multiple people in the target area;
environment information acquiring circuitry that acquires environment information indicating a state of the environment of the target area including the multiple people, from an environment detector that detects a state of the environment;
physical state information acquiring circuitry that acquires physical state information indicating physical states of the multiple people, from a physical state detector that detects a physical state of a person; and
controlling circuitry that controls the device such that states of action of the multiple people approach the target state, based on the target information, the environment information, and the physical state information,
the device control apparatus determines the target information based on input operation, which is performed in order to change atmosphere of a place in the target area, of the person and sets the atmosphere of the place, which is adjusted by the device, to the target state.

13. A device control method to be performed by a device control apparatus that controls a device for changing an environment of a target area, the method comprising:
acquiring target information indicating a target state of action of multiple people in the target area;
determining the target information based on input operation, which is performed in order to change atmosphere of a place in the target area, of the person and setting the atmosphere of the place, which is adjusted by the device, to the target state;
acquiring environment information indicating a state of the environment of the target area including the multiple people, from an environment detector that detects the state of the environment;
acquiring physical state information indicating physical states of the multiple people from a physical state detector that detects a physical state of a person; and
controlling the device such that states of action of the multiple people approach the target state, based on the target information, the environment information, and the physical state information.

14. A non-transitory computer-readable storage medium storing a device control program to be executed by a computer that controls a device for changing an environment of a target area, the device control program causing the computer to execute:
acquiring target information indicating a target state of action of multiple people in the target area;
determining the target information based on input operation, which is performed in order to change atmosphere of a place in the target area, of the person and setting the atmosphere of the place, which is adjusted by the device, to the target state;
acquiring environment information indicating a state of the environment of the target area including the multiple people, from an environment detector that detects the state of the environment;
acquiring physical state information indicating physical states of the multiple people, from a physical state detector that detects a physical state of a person; and
controlling the device such that states of action of the multiple people approach the target state, based on the target information, the environment information, and the physical state information.

15. The device control system according to claim 1, wherein the atmosphere of the place indicates activeness of action of the multiple people.

16. The device control system according to claim 2, wherein the atmosphere of the place indicates activeness of action of the multiple people.

17. The device control system according to claim 15, wherein the target information is automatically changed according to the activeness of action of the multiple people.

18. The device control system according to claim 15, wherein the target information is determined according to priority of the person.

19. The device control system according to claim 1, wherein the device control apparatus determines the target information that are different for places in the target area.
